(19) United States
(12) Patent Application Publication
(10) Pub. No.: US 2026/0354346 A1
(43) Pub. Date: Nov. 12, 2026

(54) HANDHELD PET TRAINING DEVICE

(71) Applicants: Timothy Sumner Gold, Washington, DC (US); Dan Scofield, Weston, CT (US)

(72) Inventors: Timothy Sumner Gold, Washington, DC (US); Dan Scofield, Weston, CT (US)

(21) Appl. No.: 19/201,431

(22) Filed: May 7, 2025

(51) Int. Cl. A01K 15/02; A01K 5/01

(52) U.S. Cl. CPC A01K 15/0201; A01K 5/0114

(57) ABSTRACT

A handheld pet training device for controlling an amount of a food which is released includes a housing having a base with a bottom wall, a side wall, and a spinner gear that is rotatably coupled to the side wall. The spinner gear is rotatable about a center point of the bottom wall. A lid is coupled to the base. A slot extends through the lid. A spool is positioned within the housing. The spool is engaged with the spinner gear of the base wherein rotation of the spinner gear rotates the spool. A food strip is coiled around the spool wherein rotation of the spool uncoils the food strip from the spool for extension of the food strip from the housing. The food strip extends through the slot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food dispensers and more particularly pertains to a new food dispenser for controlling an amount of a food which is released.

### (2) Description of Related Art Including Information Disclosed under 37 CFR 1.97 and 1.98

The prior art relates to food dispensers, or, more specifically, to food dispensers designed to release dog treats. In recent years, dog training techniques have increasingly incorporated manual, automated, and semi-automated treat dispensers to enhance behavior reinforcement and improve training efficiency. These devices are designed to deliver positive reinforcement through treats, helping to condition dogs to associate desired behaviors with immediate rewards. The evolution of these dispensers reflects growing demand among pet owners for tools that provide consistency, convenience, and engagement during training sessions.

Existing treat dispensers fall into several categories. Remote-controlled dispensers allow trainers to reward dogs from a distance, supporting real-time reinforcement in scenarios where physical proximity is not possible. These devices often include tutorial support and are suitable for both novice and experienced trainers. Handheld models are compact and allow for rapid, clean treat dispensing using pre-cut food items. These models are portable and easy to use during active training.

Other products incorporate interactive or cognitive features. For example, some products can be activated by the dog pressing a remote button, introducing an element of learning and memory engagement. Treat-dispensing chew toys combine play with reward-based stimulation. While these solutions offer a range of features and functionalities, there remains a need for more versatile, intuitive, and customizable treat dispensing systems that better align with various training styles and environments.

For example, rewarding dogs during training sessions often requires giving the dog multiple treats. It is therefore important to keep calories low while still offering an appealing reward. There is a need in the art for a treat dispenser that can dispense varying amounts of the treat, rather than pre-cut portions, helping to ensure portion control for the dog. Ideally, such a device would be small and compact so that it is easy for the trainer to manipulate with a single hand.

### BRIEF SUMMARY OF THE INVENTION

An embodiment of the disclosure meets the needs presented above by generally comprising a housing having a base with a bottom wall, a side wall, and a spinner gear that is rotatably coupled to the side wall wherein the spinner gear is rotatable about a center point of the bottom wall. A lid is coupled to the base. A slot extends through the lid. A spool is positioned within the housing. The spool is engaged with the spinner gear of the base wherein rotation of the spinner gear rotates the spool. A food strip is coiled around the spool wherein rotation of the spool uncoils the food strip from the spool for extension of the food strip from the housing. The food strip extends through the slot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded isometric view of a handheld pet training device according to an embodiment of the disclosure.

FIG. 2 is an exploded isometric view of an embodiment of the disclosure.

FIG. 3 is a top isometric view of an embodiment of the disclosure.

FIG. 4 is a bottom isometric view of an embodiment of the disclosure.

FIG. 5 is a top view of an embodiment of the disclosure.

FIG. 6 is a top view of an embodiment of the disclosure.

FIG. 7 is an isometric view of an embodiment of the disclosure.

FIG. 8 is an in-use view of an embodiment of the disclosure.

FIG. 9 is a detail isometric view of an embodiment of the disclosure.

### DETAILED DESCRIPTION OF THE INVENTION

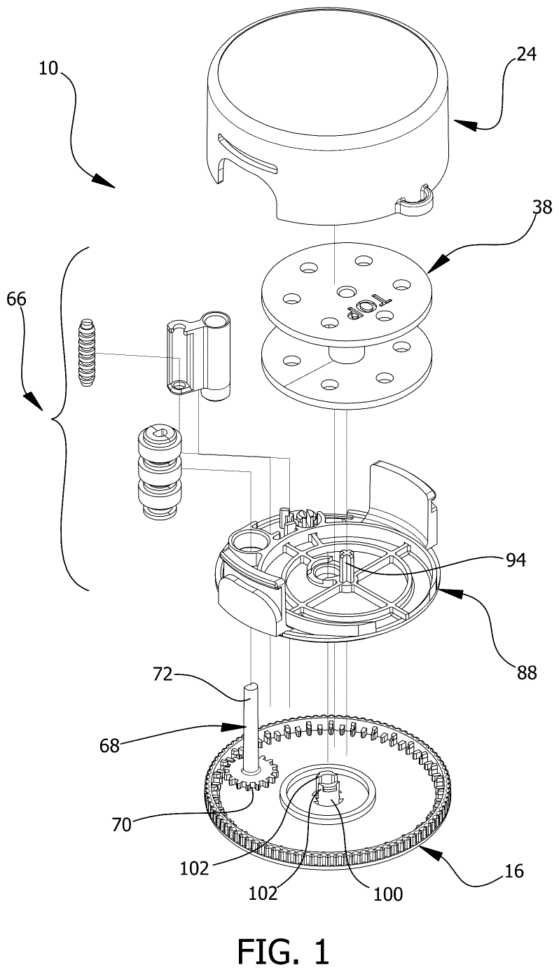

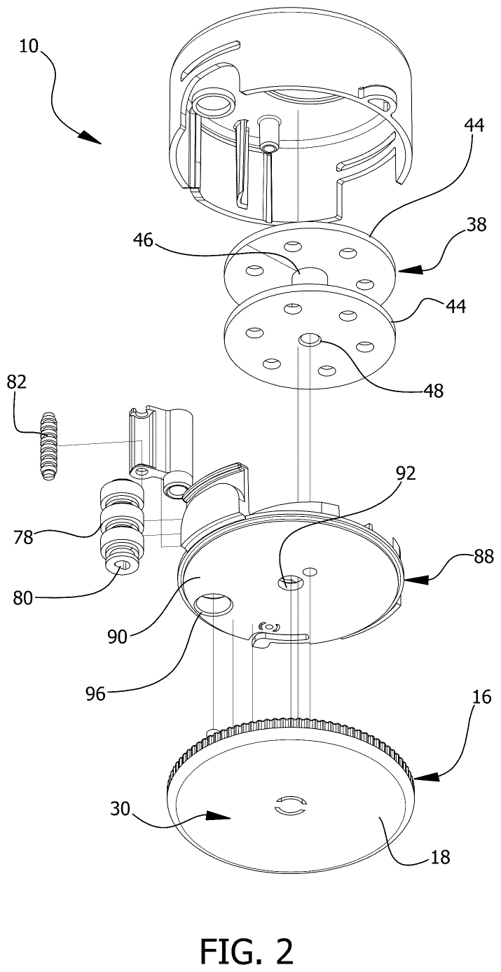

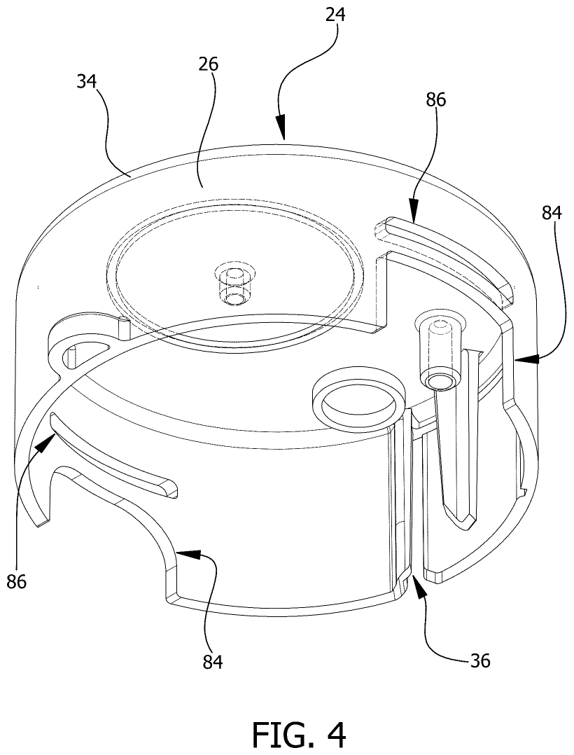

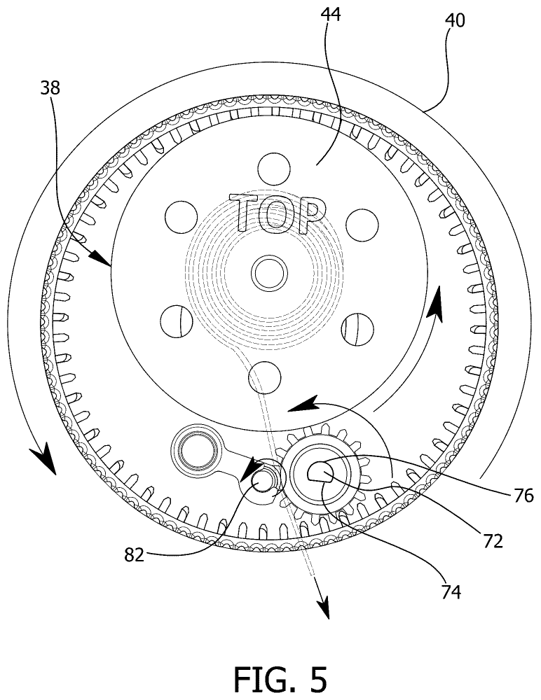

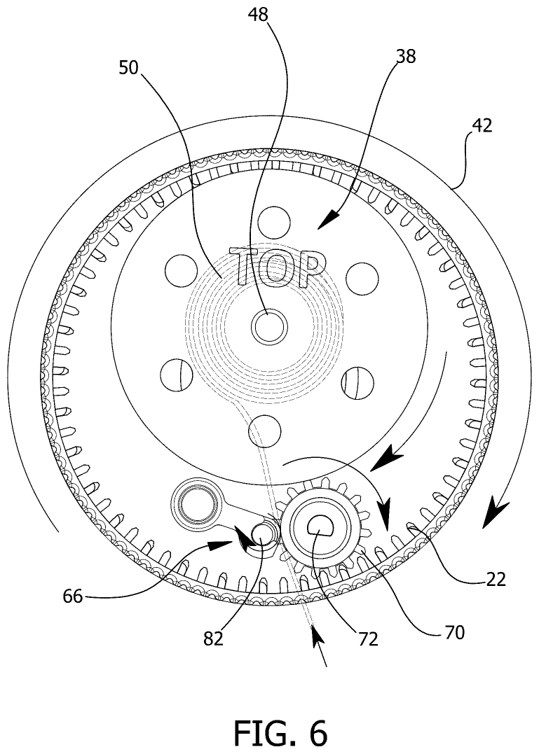

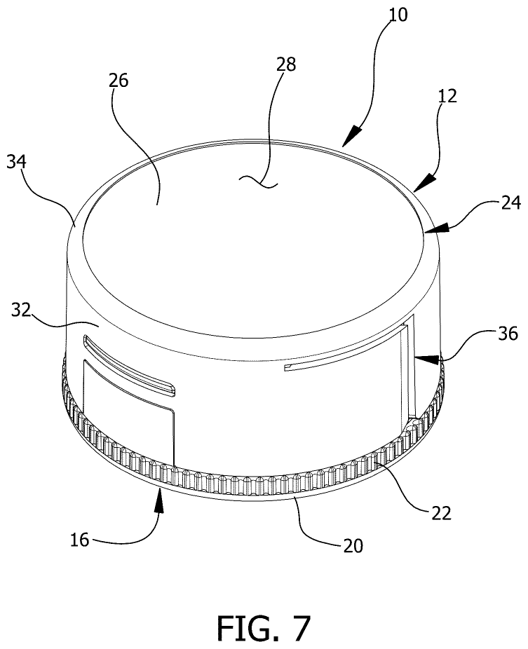

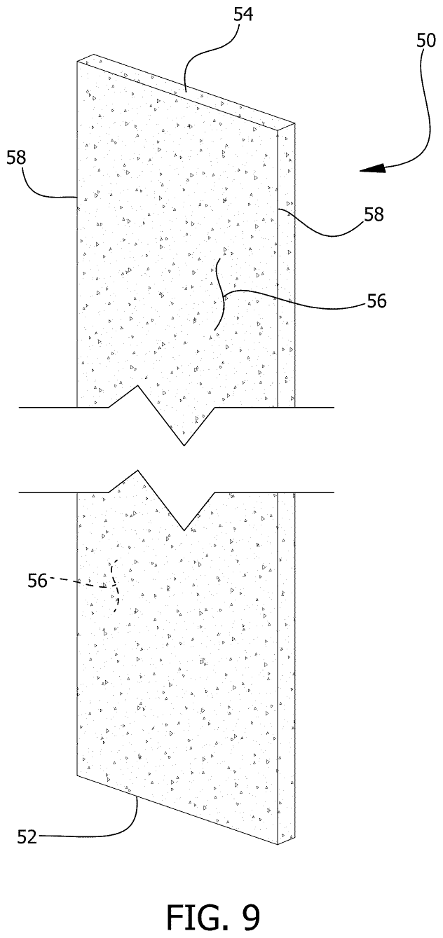

With reference now to the drawings, and in particular to FIGS. 1 through 9 thereof, a new food dispenser embodying the principles and concepts of an embodiment of the disclosure and generally designated by the reference numeral 10 will be described.

As best illustrated in FIGS. 1 through 9, the handheld pet training device 10 generally comprises a housing 12. The housing 12 may have a height that is between 0.5 inches and 2.0 inches. The diameter or width of the housing 12 may be between 1.5 inches and 2.5 inches. These dimensions are configured to make the housing 12 easily manipulatable by a single hand of a user 14.

A base 16 of the housing 12 generally includes a bottom wall 18, which may be circular wherein the diameter is measured on the bottom wall 18. A side wall 20 extends from the bottom wall 18. The side wall 20 may be curved wherein an outer surface of the side wall 20 is convexly arcuate and wherein an inner surface of the side wall 20 is concavely arcuate. Thus, the side wall 20 is configured to facilitate the user 14 in gripping the housing 12 with the single hand.

A spinner gear 22 is rotatably coupled to the side wall 20. The spinner gear 22 is rotatable about a center point of the bottom wall 18. Generally, the spinner gear 22 is rotatable 360° in each of a first direction 40 and a second direction 42. The spinner gear 22 may have a toothed exterior surface that is configured to facilitate the user 14 in rotating the spinner gear 22 with the single hand. Specifically, the toothed exterior surface increases friction between the spinner gear 22 and the single hand of the user 14. For example, the user 14 may hold the housing 12 in the single hand and rotate the spinner gear 12 with the thumb of that hand. The spinner gear 22 also has a toothed interior surface extending inwardly over the bottom wall 18.

A lid 24 is coupled to the base 16. The lid 24 may include a top wall 26. The top wall 26 may be circular with the same diameter as the diameter of the bottom wall 18, which defines the diameter of the housing 12 itself. The height of the housing 12 is generally measured from an upper surface 28 of the top wall 26 to a lower surface 30 of the bottom wall 18. The housing 12 is preferably cylindrical, such that each of the bottom wall 18 of the base 16 and the top wall 26 of the lid 24 are circular, although alternative shapes are also considered. In these embodiments, the diameter of the housing 12 may more specifically be measured across the lower surface 30 of the bottom wall 18. When the shape of the housing 12 is not cylindrical, the diameter of the housing 12 may instead be called the width of the housing 12.

A peripheral wall 32 may be coupled to and extend from the top wall 26. The peripheral wall 32 has an upper edge 34 defining a junction between the peripheral wall 32 and the top wall 26. The upper edge 34 may be curved wherein an exterior surface of the upper edge 34 is convexly arcuate and wherein an interior surface of the upper edge 34 is concavely arcuate. Thus, the upper edge 34 is also configured to facilitate the user 14 in gripping the housing 12 with the single hand. A slot 36 extends through the peripheral wall 32 of the lid 24.

A spool 38 is positioned within the housing 12. The spool 38 is engaged with the spinner gear 22 of the base 16. Rotation of the spinner gear 22 in rotates the spool 38. For example, when the spinner gear 22 is rotated in the first direction, the spool 38 may also rotate in the first direction 40. Accordingly, rotation of the spinner gear 22 in the second direction 42 may rotate the spool 38 in the second direction 42.

The spool 38 may include a pair of flanges 44. A barrel 46 may be coupled to and extend between the pair of flanges 44. The barrel 46 typically has a diameter that is less than a diameter of the pair of flanges 44. Additionally, the barrel 46 may be centered on each flange of the pair of flanges 44. A channel 48 may extend through each flange of the pair of flanges 44 and the barrel 46. In other embodiments, the channel 48 may extend through a bottom-facing flange of the pair of flanges 44 into the barrel 46. The bottom-facing flange of the pair of flanges 44 faces toward the bottom wall 18 of the base. In still other embodiments, the channel 48 may extend into the bottom-facing flange of the pair of flanges 44 and have a depth that is less than a width of the bottom-facing flange of the pair of flanges 44 such that the channel 48 is fully positioned outside of the barrel 46. However, extension of the channel 48 at least through the bottom-facing flange of the pair of flanges 44 into the barrel 46 is preferred to facilitate stability of the spool 38 when the spool 38 is rotated. That is because the bottom-facing flange of the pair of flanges 44 is generally coupled to the base 16, as explained further below. The channel 48 is preferably centered on the barrel 46, which may also facilitate stability of the spool 38 during rotation.

A food strip 50 is coiled around the spool 38. Typically, the food strip 50 is positioned around the barrel 46 between the pair of flanges 44. Rotation of the spool 38 40 uncoils the food strip 50 from the spool 38 for extension of the food strip 50 from the housing 12. For example, the food strip 50 may be uncoiled from the spool 38 while the spool 38 is rotated in the first direction. In such embodiments, rotation of the spool 38 in the second direction 42 may coil the food strip 50 around the spool 38 for retraction of the food strip 50 into the housing 12. The food strip 50 extends through the slot 36 in the lid 24 when the food strip 50 is extended from and retracted into the housing 12.

The food strip 50 is typically a pet treat. In other words, the food strip 50 is configured for being eaten by a pet to facilitate the user 14 in training the pet. Accordingly, the food strip 50 may be made of ingredients which are safe for consumption by the pet, such as sweet potatoes, applesauce, and bone broth. The ingredients are also configured to make the food strip 50 tasty for the pet while keeping the food strip 50 low in calories. This provides positive reinforcement while minimizing the risk of overfeeding the pet or causing undue weight gain. Ideally, the ingredients are also configured to facilitate health of the pet, providing vitamins, fiber, antioxidants, and other health benefits.

The food strip 50 comprises a flexible material. The flexible material facilitates the food strip 50 in being coiled around and uncoiled from the spool 38. Moreover, the flexible material is configured to facilitate the user 14 in tearing the food strip 50 into a plurality of pieces for the pet. The ingredients of the food strip 50 are thus chosen to maintain flexibility, prevent crumbling, and ensure the food strip 50 can be torn into the plurality of pieces. The plurality of pieces facilitate portion control while also providing a tasty and nutritious treat for providing positive reinforcement for the pet as the user 14 is training the pet.

Training sessions typically involve repeated practice of behaviors, and repeated rewards for when the pet successfully completes the behaviors. Portion control is very important in such situations, so the food strip 50 is preferably tearable because of the flexible material to allow the user 14 to determine the size of the plurality of pieces as needed. The food strip 50 is not necessarily tearable because it is serrated or otherwise sectioned into pre-determined sizes of the plurality of pieces to provide the user 14 with the ability to determine the right size of the plurality of pieces for each particular situation.

The ingredients are also chosen to inhibit the food strip 50 from crumbling and making a mess, either on the hands of the user 14 or in the area around which the user 14 is training the pet. The food strip 50 is also not sticky or slimy because the ingredients are configured to inhibit the food strip 50 from leaving residue on the hands of the user 14. The food strip 50 and the housing 12 are also easy to store and highly portable because the food strip 50 is coiled around the spool 38 within the housing 12 which is configured for use by the single hand of the user 14. Thus, waste is minimized.

Structurally, the food strip 50 may include a leading end 52 that extends outwardly from the housing 12 when the food strip 50 is uncoiled from the spool 38. A trailing end 54 of the food strip 50 is distally positioned relative to the leading end 52. A length of the food strip 50 is measured between the leading end 52 and the trailing end 54. For example, the length may be between 25.0 inches and 45.0 inches.

A pair of opposing surfaces 56 extend between the leading end 52 and the trailing end 54. A thickness of the food strip 50 is measured between the pair of opposing surfaces 56. The thickness is less than the length. Preferably, the thickness is between 0.02 inches and 0.06 inches. A pair of opposing edges 58 extending between the leading end 52 and the trailing end 54.

A width is measured between the pair of opposing edges 58. The width is less than the diameter of the barrel 46 wherein the food strip 50 is positionable on the barrel 46 between the pair of flanges 44 of the spool 38 whereby the pair of flanges 44 of the spool 38 inhibit the food strip 50 from slipping off of the barrel 46. For example, the width may be between 0.25 inches and 1.5 inches.

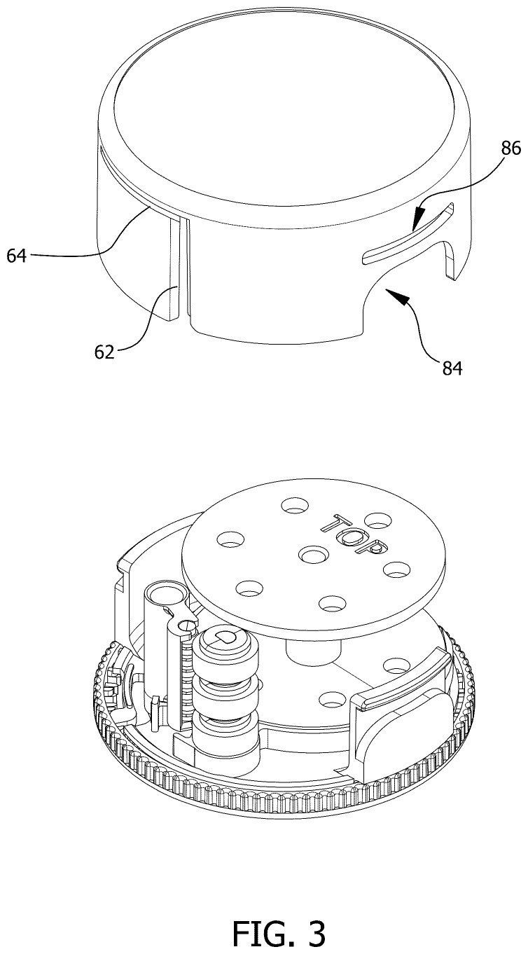

The slot 36 that extends through the lid 24 of the housing 12 may have a releasing portion 62. The releasing portion 62 may be perpendicular to the top wall 26 of the lid 24. The food strip 50 extends outwardly from the housing 12 through the releasing portion 62 of the slot 36 when the food strip 50 is uncoiled from the spool 38. A tearing portion 64 of the slot 36 may extend from the releasing portion 62. The tearing portion 64 is spaced from the top wall 26. The tearing portion 64 may be parallel to the top wall 26. More importantly, the tearing portion 64 is generally angled relative to the releasing portion 62, for example being perpendicular to the releasing portion 62 as shown in FIG. 3.

The food strip 50 may be movable into the tearing portion 64 wherein the tearing portion 64 is configured to facilitate the user 14 in tearing the food strip 50 into the plurality of pieces. The flexible material of the food strip 50 facilitates the user 14 in moving the portion of the food strip 50 which extends outwardly from the housing 12 from the releasing portion 62 of the slot 36 into the tearing portion. The tearing portion 64 of the slot 36 may have a sharpened edge to further facilitate the user 14 in tearing the food strip 50. Preferably, the sharpened edge of the tearing portion 64 is made of plastic or other non-metallic materials to inhibit the sharpened edge from injuring the user 14.

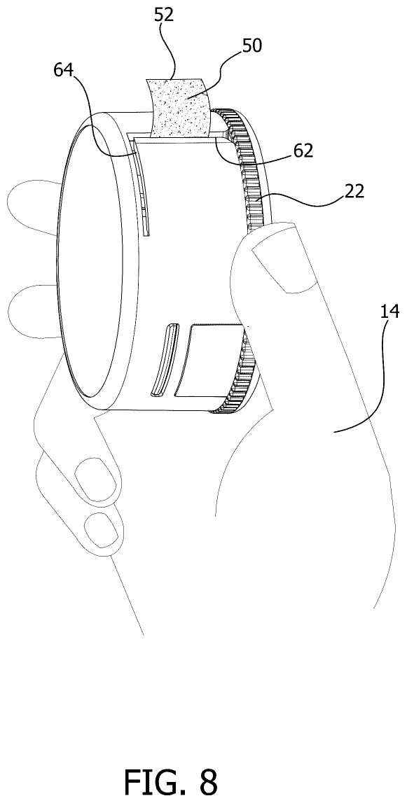

More specifically, the user 14 may rotate the spinner gear 22, which in turn rotates the spool 38 to uncoil the food strip 50 for extension of the food strip 50 from the housing 12. The food strip 50 is generally aligned with the releasing portion 62 of the slot 36 such that the food strip 50 extends outwardly from the housing 12 through the releasing portion 62, as shown in FIG. 8. When the user 14 is tearing the food strip 50 into a piece of the plurality of pieces, the user 14 can pull the food strip 50 into the tearing portion 64, which will facilitate the user 14 in tearing or ripping the piece of the plurality of pieces from the food strip 50 within the housing 12. Because the food strip 50 is preferably flexible and pliable enough to be torn by hand, the tearing portion 64 need not include blades or sharpened edges, thereby inhibiting the handheld pet training device 10 from cutting or otherwise injuring the user 14.

A guide 66 is typically positioned within the housing 12. The guide 66 is in contact with the food strip 50. The guide 66 directs the food strip 50 into the slot and inhibits the food strip 50 from being horizontally folded within the housing 12 as the food strip 50 is being extended from and retracted into the housing 12.

For example, a gear stem 68 may be in physical contact with the spinner gear 22 of the base 16 of the housing 12. Rotation of the spinner gear 22 rotates the gear stem 68. More specifically, rotation of the spinner gear 22 in the first direction 40 may rotate the gear stem 68 in the first direction 40. Conversely, Rotation of the spinner gear 22 in the second direction 42 may rotate the gear stem 68 in the second direction 42.

As shown in FIG. 1, the gear stem 68 may include a wheel 70 with a toothed perimeter that is engaged with the toothed interior surface of the spinner gear 22. Because of the engagement between the toothed perimeter of the wheel 70 and the toothed interior surface of the spinner gear 22, rotation of the spinner gear 22 about the center point of the bottom wall 18 rotates the wheel 70 about a center point of the wheel 70.

A rod 72 extends upwardly from the wheel 70 wherein rotation of the wheel 70 rotates the rod 72. The rod 72 is positioned on the center point of the wheel 70. As shown in FIGS. 1 and 3, the rod 72 may have a planar surface 74 and an arcuate surface 76 that extends between opposing ends of the planar surface 74. This configuration gives the rod 72 a half-cylinder shape.

A bushing 78 is coupled to the rod 72 of the gear stem 68 wherein rotation of the gear stem 68 rotates the bushing 78. The bushing 78 has a through-hole 80 with a shape that is complementary to a shape of the rod 72. The planar surface 74 of the rod 72 urges the bushing 78 to rotate as the gear stem 68 is rotated. The shape of the through-hole 80 and the rod 72 also couples the bushing 78 to the rod 72 of the gear stem 68 via a friction fit.

A roller 82 is spaced from the bushing 78 by a distance that is complementary to the thickness of the food strip 50. The food strip 50 effectively couples the bushing 78 to the roller 82 via a friction fit. Thus, rotation of the bushing 78 in the first direction 40 may rotate the roller 82 in the first direction 40 to uncoil the food strip 50 from the spool 38 for extension of the food strip 50 from the housing 12. Rotation of the bushing 78 in the second direction 42 may rotate the roller 82 in the second direction 42 to coil the food strip 50 around the spool 38 for retraction of the food strip 50 into the housing 12. The roller 82 and the bushing 78 are positioned proximate to the releasing portion 62 of the slit wherein a space between the bushing 78 and the roller 82 is aligned with the releasing portion 62 of the slit to facilitate the food strip 50 in extending from the housing 12 through the releasing portion 62.

A pair of cutouts 84 extend upwardly through a lower edge of the peripheral wall 32 of the lid 24. Each cutout of the pair of cutouts 84 has a height that is less than a height of the peripheral wall 32 wherein the pair of cutouts 84 are spaced from the top wall 26. The pair of cutouts 84 may be aligned with each other across a diameter of the top wall 26. A pair of notches 86 extend through the peripheral wall 32 of the lid 24. Each notch of the pair of notches 86 is vertically aligned with an associated cutout of the pair of cutouts 84. More specifically, each notch of the pair of notches 86 may be positioned between the associated cutout of the pair of cutouts 84 and the top wall 26.

A hub 88 is coupled to the bottom wall 18 of the base 16 of the housing 12. The hub 88 has a plate 90 with a diameter that is less than a diameter of the bottom wall 18 of the base 16 wherein the plate 90 is positionable on the bottom wall 18. A bore hole 92 extends through the plate 90. The bore hole 92 is centered on the plate 90 wherein the bore hole 92 is aligned with the center point of the bottom wall 18 of the base 16.

A spindle 94 is coupled to and extends upwardly from the plate 90. The spool 38 is positionable on the spindle 94 wherein the spool 38 is rotatable about the spindle 94. The spindle 94 thus generally has a diameter that is less than a diameter of the channel 48 extending through the spool 38. The spool 38 may rotate freely about the spindle 94 and may be removable from the spindle 94 when the lid 24 is decoupled from the base 16. The spindle 94 may be positioned adjacent to the bore hole 92 wherein the spindle 94 is offset from the center point of the bottom wall 18 of the base 16.

A recess 96 extends through the plate 90. The recess 96 is positioned proximate to a perimeter edge of the plate 90. The recess 96 has a size exceeding a size of the rod 72 of the gear stem 68 wherein the rod 72 of the gear stem 68 extends through the recess 96. The recess 96 thus secures a position of the gear stem 68 on the base 16 while the gear stem 68 is rotated by the spinner gear 22 of the base 16 of the housing 12. Because the gear stem 68 is positioned within the recess 96, the gear stem 68 rotates about the center point of the wheel 70 instead of rotating about the center point of the bottom wall 18 of the base 12. The recess 96 may also have a diameter exceeding a diameter of the bushing 78 wherein the bushing 78 is positionable within the recess 96 to couple the bushing 78 to the gear stem 68 and to secure a position of the bushing 78 on the plate 90.

A pair of clips 98 is coupled to and extends from the plate 90. Each clip of the pair of clips 98 has a shape that is complementary to a shape of a respective notch of the pair of notches 86 and to a shape of the associated cutout of the pair of cutouts 84 wherein each clip of the pair of clips 98 is engageable with the respective notch of the pair of notches 86 and the associated cutout of the pair of cutouts 84 to couple the lid 24 to the base 16. The pair of clips 98 may be pivotably coupled to the hub 88 wherein the pair of clips 98 are configured to pivot inwardly toward each other when the user 14 presses on the pair of clips 98 to remove the lid 24 from the base 16. For example, the user 14 may remove the lid 24 from the base 16 to replace the food strip 50 as needed.

A coupler 100 may be attached to the bottom wall 18 of the base 16. The coupler 100 is positionable within the bore hole 92 of the hub 88 to removably couple the hub 88 to the base 16. The coupler 100 is thus generally positioned on the center point of the bottom wall 18 of the base 16. The coupler 100 may have a pair of fingers 102 that are pivotable outwardly from each other wherein the pair of fingers 102 pivot outwardly from each other within the bore hole 92 to secure the hub 88 to the base 16.

In use, the food strip 50 can be coiled around the spool 38, either during a manufacturing stage or manually by the user 14. The user 14 can rotate the spinner gear 22, for example with the thumb of the single hand in which the housing 12 is held, to dispense the food strip 50 through the slot 36. Once the desired length of the food strip 50 is extended from the housing 12, the user 14 can simply stop rotating the spinner gear 22 and tear off the piece of the food strip 50 which has been dispensed. For example, the desired length may be between 0.2 inches and 0.6 inches. The user 14 may pull the food strip 50 toward the tearing portion 64 of the slot 36 to easily tear off the piece and give it to the pet. To refill the housing 12 with the food strip 50, the lid 24 can be removed from the base 16. The spool 38 may be removed from the spindle 94 of the hub 88 and a replacement food strip 50 can be coiled around the barrel 46 of the spool 38. The spool 38 can then easily be repositioned on the spindle 94 and the lid 24 may be recoupled to the base 16 by inserting the pair of clips 98 into the pair of notches 86 and the pair of cutouts 84.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A treat dispenser device comprising:
a housing including:
a base including:
a bottom wall;
a side wall; and
a spinner gear being rotatably coupled to the side wall wherein the spinner gear is rotatable about a center point of the bottom wall;
a lid being coupled to the base;
a slot extending through the lid;
a spool being positioned within the housing, the spool being engaged with the spinner gear of the base wherein rotation of the spinner gear rotates the spool;
a food strip being coiled around the spool wherein rotation of the spool uncoils the food strip from the spool for extension of the food strip from the housing, the food strip extending through the slot; and
a hub being coupled to the bottom wall of the base of the housing, the hub including:
a plate having a diameter being less than a diameter of the bottom wall; and
a spindle being coupled to and extending upwardly from the plate, the spool being positioned on the spindle wherein the spool is rotatable about the spindle.

2. The treat dispenser device of claim 1, wherein the food strip comprises a pet treat wherein the food strip is configured for being eaten by a pet.

3. The treat dispenser device of claim 2, wherein the food strip comprises a flexible material wherein the flexible material facilitates the food strip in being coiled around and uncoiled from the spool and wherein the flexible material is configured to facilitate a user in tearing the food strip into a plurality of pieces for the pet.

4. The treat dispenser device of claim 1, further comprising a guide being positioned within the housing, the guide being in contact with the food strip wherein the guide is configured to inhibit the food strip from being horizontally folded while the food strip is being extended from and retracted into the housing.

5. The treat dispenser device of claim 4, the guide further comprising:
a gear stem being in physical contact with the spinner gear of the base of the housing wherein rotation of the spinner gear rotates the gear stem;
a bushing being coupled to the gear stem wherein rotation of the gear stem rotates the bushing; and
a roller being spaced from the bushing by a distance being complementary to a thickness of the food strip, wherein the food strip couples the bushing to the roller via a friction fit the roller and the bushing being configured such that rotation of the bushing rotates the roller to uncoil the food strip from the spool for extension of the food strip from the housing.

6. The treat dispenser of claim 5, the gear stem further comprising:
a wheel having a toothed perimeter being engaged with a toothed interior surface of the spinner gear wherein rotation of the spinner gear about the center point of the bottom wall rotates the wheel about a center point of the wheel; and
a rod extending upwardly from the wheel wherein rotation of the wheel rotates the rod.

7. The treat dispenser of claim 6, wherein the rod is positioned on the center point of the wheel.

8. The treat dispenser of claim 6, the rod further comprising:
a planar surface; and
an arcuate surface extending between opposing ends of the planar surface.

9. The treat dispenser of claim 8, the bushing further comprising a through-hole with a shape being complementary to a shape of the rod wherein the planar surface of the rod is configured to urge the bushing to rotate as the gear stem is rotated and wherein the bushing is coupled to the rod of the gear stem via a friction fit.

10. (canceled)

11. (canceled)

12. The treat dispenser of claim 1, wherein the spindle has a diameter being less than a diameter of a channel extending through the spool wherein the spool is configured to rotate freely about the spindle.

13. The treat dispenser of claim 1, wherein the lid of the housing is removably couplable to the base.

14. The treat dispenser of claim 13, further comprising:
a pair of cutouts extending upwardly through a lower edge of the lid;
a pair of notches extending through the peripheral wall of the lid, each notch of the pair of notches being aligned with an associated cutout of the pair of cutouts; and
a pair of clips being coupled to and extending from the plate of the hub, each clip of the pair of clips having a shape being complementary to a shape of a respective notch of the pair of notches and to a shape of the associated cutout of the pair of cutouts wherein each clip of the pair of clips is engageable with the respective notch of the pair of notches and the associated cutout of the pair of cutouts to couple the lid to the base.

15. The treat dispenser of claim 14, wherein the pair of cutouts are aligned with each other across a diameter of the lid.

16. The treat dispenser device of claim 1, further comprising:
a bore hole extending through the plate; and
a coupler being attached to the bottom wall of the base, wherein the coupler is positionable within the bore hole of the hub to removably couple the hub to the base.

17. The treat dispenser of claim 16, wherein the bore hole is centered on the plate and wherein the bore hole is aligned with the center point of the bottom wall.

18. The treat dispenser of claim 17, wherein the spindle is positioned adjacent to the bore hole, wherein the spindle is offset from the center point of the bottom wall.

19. The treat dispenser of claim 1, wherein the spinner gear is rotatable in each of a first direction and a second direction, wherein the treat dispenser is configured such that:
when the spinner gear is rotated in the first direction, the spool is rotated in the first direction;
rotation of the spool in the first direction uncoiling the food strip from the spool for extension of the food strip from the housing;
when the spinner gear is rotated in the second direction, the spool is rotated in the second direction;
rotation of the spool in the second direction coiling the food strip around the spool for retraction of the food strip into the housing.

20. A treat dispenser device comprising:
a housing having a height being between 0.5 inches and 1.5 inches and a diameter being between 1.5 inches and 2.5 inches wherein the housing is configured for being manipulated by a single hand of a user, the housing including:
a base including:
a bottom wall being circular wherein the diameter is measured on the bottom wall;
a side wall being curved wherein an outer surface of the side wall is convexly arcuate and wherein an inner surface of the side wall is concavely arcuate whereby the side wall is configured to facilitate the user in gripping the housing with the single hand; and
a spinner gear being rotatably coupled to the side wall wherein the spinner gear is rotatable about a center point of the bottom wall, the spinner gear being rotatable 360°in each of a first direction and a second direction, the spinner gear having a toothed exterior surface wherein the toothed exterior surface is configured to facilitate the user in rotating the spinner gear with the single hand, the spinner gear having a toothed interior surface extending inwardly over the bottom wall;
a lid being coupled to the base, the lid including:
a top wall being circular, the height of the housing being measured from an upper surface of the top wall to a lower surface of the bottom wall; and
a peripheral wall being coupled to and extending from the top wall, the peripheral wall including:
an upper edge defining a junction between the peripheral wall and the top wall, the upper edge being curved wherein an exterior surface of the upper edge is convexly arcuate and wherein an interior surface of the upper edge is concavely arcuate whereby the upper edge is configured to facilitate the user in gripping the housing with the single hand;
a slot extending through the peripheral wall of the lid;
a spool being positioned within the housing, the spool being engaged with the spinner gear of the base wherein rotation of the spinner gear in the first direction rotates the spool in the first direction and wherein rotation of the spinner gear in the second direction rotates the spool in the second direction, the spool including:
a pair of flanges;
a barrel being coupled to and extending between the pair of flanges, the barrel having a diameter being less than a diameter of the pair of flanges, the barrel being centered on the pair of flanges; and
a channel extending through the pair of flanges and the barrel, the channel being centered on the barrel;
a food strip being coiled around the barrel of the spool wherein rotation of the spool in the first direction uncoils the food strip from the spool for extension of the food strip from the housing and wherein rotation of the spool in the second direction coils the food strip around the spool for retraction of the food strip into the housing, the food strip extending through the slot when the food strip is extended from and retracted into the housing, the food strip comprising a pet treat wherein the food strip is configured for being eaten by a pet to facilitate the user in training the pet, the food strip comprising a flexible material wherein the flexible material facilitates the food strip in being coiled around and uncoiled from the spool and wherein the flexible material is configured to facilitate the user in tearing the food strip into a plurality of pieces for the pet, the food strip including:
a leading end extending outwardly from the housing when the food strip is uncoiled from the spool;
a trailing end being distally positioned relative to the leading end;
a length being measured between the leading end and the trailing end;
a pair of opposing surfaces extending between the leading end and the trailing end;
a thickness being measured between the pair of opposing surfaces, the thickness being less than the length;
a pair of opposing edges extending between the leading end and the trailing end; and
a width being measured between the pair of opposing edges, the width being less than the diameter of the barrel wherein the food strip is positionable on the barrel between the pair of flanges of the spool whereby the pair of flanges of the spool inhibit the food strip from slipping off of the barrel;
the slot extending through the lid of the housing further comprising:
a releasing portion being perpendicular to the top wall of the lid, the food strip extending outwardly from the housing through the releasing portion of the slot when the food strip is uncoiled from the spool; and
a tearing portion extending from the releasing portion, the tearing portion being spaced from the top wall, the tearing portion being parallel to the top wall, the food strip being movable into the tearing portion wherein the tearing portion is configured to facilitate the user in tearing the food strip into the plurality of pieces;
a guide being positioned within the housing, the guide being in contact with the food strip wherein the guide is configured to inhibit the food strip from being horizontally folded while the food strip is being extended from and retracted into the housing, the guide including:
a gear stem being in physical contact with the spinner gear of the base of the housing wherein rotation of the spinner gear in the first direction rotates the gear stem in the first direction and wherein rotation of the spinner gear in the second direction rotates the gear stem in the second direction, the gear stem including:
a wheel having a toothed perimeter being engaged with the toothed interior surface of the spinner gear wherein rotation of the spinner gear about the center point of the bottom wall rotates the wheel about a center point of the wheel; and
a rod extending upwardly from the wheel wherein rotation of the wheel rotates the rod, the rod being positioned on the center point of the wheel, the rod including:
a planar surface; and
an arcuate surface extending between opposing ends of the planar surface;
a bushing being coupled to the rod of the gear stem wherein rotation of the gear stem in the first direction rotates the bushing in the first direction, the bushing having a through-hole with a shape being complementary to a shape of the rod wherein the planar surface of the rod is configured to urge the bushing to rotate in the first direction as the gear stem is rotated in the first direction and wherein the bushing is coupled to the rod of the gear stem via a friction fit; and
a roller being spaced from the bushing by a distance being complementary to the thickness of the food strip, wherein the food strip couples the bushing to the roller via a friction fit, rotation of the bushing in the first direction rotating the roller in the first direction to uncoil the food strip from the spool for extension of the food strip from the housing, rotation of the bushing in the second direction rotating the roller in the second direction to coil the food strip around the spool for retraction of the food strip into the housing, the roller and the bushing being positioned proximate to the releasing portion of the slit wherein a space between the bushing and the roller is aligned with the releasing portion of the slit to facilitate the food strip in extending from the housing through the releasing portion;
a pair of cutouts extending upwardly through a lower edge of the peripheral wall of the lid, each cutout of the pair of cutouts having a height being less than a height of the peripheral wall wherein the pair of cutouts are spaced from the top wall, the pair of cutouts being aligned with each other across a diameter of the top wall;
a pair of notches extending through the peripheral wall of the lid, each notch of the pair of notches being vertically aligned with an associated cutout of the pair of cutouts wherein each notch of the pair of notches is positioned between the associated cutout of the pair of cutouts and the top wall;
a hub being coupled to the bottom wall of the base of the housing, the hub including:
a plate having a diameter being less than a diameter of the bottom wall of the base wherein the plate is positionable on the bottom wall;
a bore hole extending through the plate, the bore hole being centered on the plate wherein the bore hole is aligned with the center point of the bottom wall of the base;
a spindle being coupled to and extending upwardly from the plate, the spool being positionable on the spindle wherein the spool is rotatable about the spindle, the spindle being positioned adjacent to the bore hole, wherein the spindle is offset from the center point of the bottom wall of the base, the spindle having a diameter being less than a diameter of the channel extending through the spool wherein the spool is configured to rotate freely about the spindle and wherein the spool is removable from the spindle when the lid is decoupled from the base; and
a recess extending through the plate, the recess being positioned proximate to a perimeter edge of the plate, the recess having a size exceeding a size of the rod of the gear stem wherein the rod of the gear stem extends through the recess whereby the recess secures a position of the gear stem on the base while the gear stem is rotated by the spinner gear of the base of the housing, the recess having a diameter exceeding a diameter of the bushing wherein the bushing is positionable within the recess to couple the bushing to the gear stem; and
a pair of clips being coupled to and extending from the plate, each clip of the pair of clips having a shape being complementary to a shape of a respective notch of the pair of notches and to a shape of the associated cutout of the pair of cutouts wherein each clip of the pair of clips is engageable with the respective notch of the pair of notches and the associated cutout of the pair of cutouts to couple the lid to the base, the pair of clips being pivotably coupled to the hub wherein the pair of clips are configured to pivot inwardly toward each other when the user presses on the pair of clips to remove the lid from the base; and
a coupler being attached to the bottom wall of the base, wherein the coupler is positionable within the bore hole of the hub to removably couple the hub to the base, the coupler being positioned on the center point of the bottom wall of the base, the coupler having a pair of fingers being pivotable outwardly from each other wherein the pair of fingers pivot outwardly from each other within the bore hole to secure the hub to the base.
